(19) United States
(12) Patent Application Publication
(10) Pub. No.: US 2008/0070092 A1
(43) Pub. Date: Mar. 20, 2008

(54) METAL/COMPOSITE HYBRID FUEL CELL ASSEMBLY

(76) Inventor: Jack A.C. Kummerow, Paris, TN (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/532,344

(22) Filed: Sep. 15, 2006

(51) Int. Cl. H01M 4/86; H01M 4/96

(52) U.S. Cl. 429/40; 429/44

(57) ABSTRACT

A fuel cell assembly having a composite anode and a metallic cathode is disclosed. The metallic cathode provides strength and durability to the fuel cell assembly while the composite anode provides resistance to corrosion caused by the anode environment.

### BACKGROUND

1. Field

The present application relates generally to fuel cells, and more particularly to methods and materials for forming fuel cell assemblies.

2. Background

Bi-polar fuel cell assemblies typically consist of two electrode plates, i.e., a cathode and an anode, and a separator plate disposed between the two electrode plates. Conventional electrode plates are formed of metal or composite materials. Although fuel cell assemblies formed using purely metal electrodes are durable, such plates can be heavy and quite susceptible to corrosion due to oxidation and the electrochemical environment produced by the fuel cell assembly. Composite materials aid to reduce the overall weight and susceptibility to corrosion of fuel cell assemblies but lack strength and are susceptible to cracking during handling.

The subject matter herein helps overcome, or at least mitigate one or more of the problems described above associated with fell cell assemblies.

### SUMMARY

In one embodiment, the present invention provides a fuel cell assembly having a cathode plate formed from a metallic material, an anode plate formed of a composite material, and a separator disposed between the two plates. The composite anode plate is corrosion resistant and is preferably formed from a non-metallic material.

### BRIEF DESCRIPTION OF THE DRAWINGS

FIG. 1 is an exploded view of a fuel cell assembly.

### DETAILED DESCRIPTION

Although described herein as a single fuel cell assembly, it is appreciated that several assemblies can be combined to form a fuel cell stack without exceeding the scope of the invention.

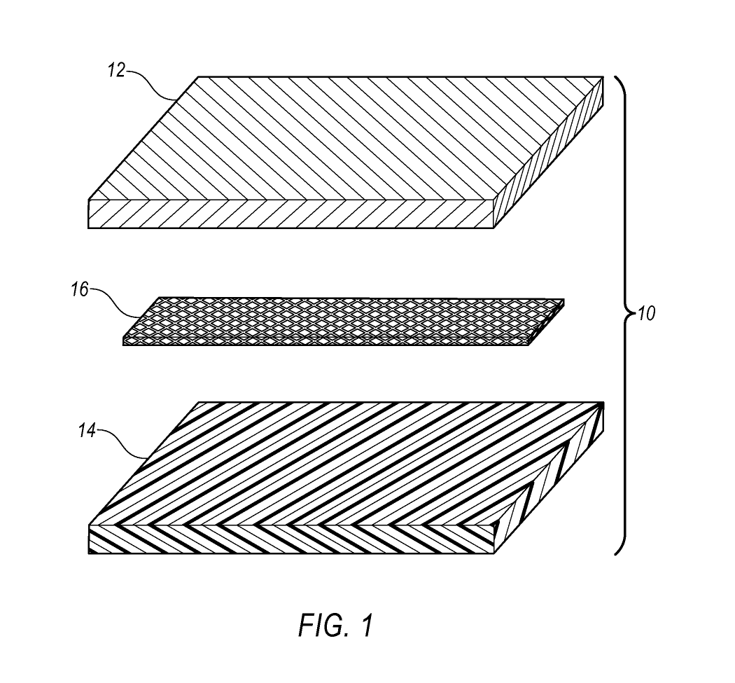

FIG. 1 shows an exploded cross sectional view (not to scale) of a representative fuel cell assembly 10. As illustrated, the fuel cell assembly 10 includes a cathode plate 12, an anode plate 14 and a separator 16 disposed between the cathode 12 and anode 14 plates. Each plate is made of an electron conducting material.

The cathode plate 12 is formed of a metallic material suitable for use in a fuel cell environment. Illustratively, the cathode plate 12 may be formed of various metallic materials including, but not limited to, graphite, aluminum or other metals. The cathode plate 12 is configured to provide strength and durability to the fuel cell assembly 10 to reduce the risk of damage caused during handling and/or shipping. Other materials known to those skilled in the art, or may become known in the future, may be suitable for use in forming the cathode plate 12 which provide similar levels of strength and durability as metal.

The anode plate 14 is formed of a composite material that is configured to provide corrosion resistance to the harsh anode environment which can be highly acidic. Also, forming the anode plate 14 from a composite material helps to reduce the oxidative damage caused to the fuel call assembly 10 from the electrochemical environment. Preferably, the anode plate 14 is formed of a non-metallic material such as, for example, BMC940 sold by Bulk Molding Corporation. It is understood that other suitable non-metallic material may also be used without departing from the aims of the invention. Indeed, the anode plate 14 may be formed of various composite materials including, but not limited to, graphite particles imbedded in a thermosetting or thermoplastic polymer matrix.

The separator 16 is disposed between the cathode 12 and anode 14 plates prior to bonding of the fuel cell assembly 10. The separator 16 may be impregnated or coated with an adhesive prior to bonding. To increase the strength and durability of the fuel cell assembly 10, the separator 16 may be formed of a reinforcing material including, but not limited to, carbon fiber cloth, paper, cardboard, fiberglass or combinations thereof. It is appreciated that several techniques are known to those skilled in the art which are suitable for bonding the fuel assembly 10 and use of either of such techniques would not exceed the scope of the invention.

For metallic plates, the anode environment is the most damaging, since not only is the metal subject to an acidic environment, but the metal can be oxidized by the cell potential. By replacing the metallic anode with a composite anode plate 14 and bonding it to the metallic cathode plate 12, the worst features of the purely composite or metal fuel cell assemblies are avoided. The metal cathode plate 12 provides strength to the composite anode plate 14 while the composite anode plate 14 provides corrosion resistance to the harsh anode environment. The resulting fuel cell assembly 10 of the metal anode plate 12 and the composite cathode plate 14 may provide less weight than a purely metal fuel cell assembly while being thinner than a composite only assembly. Also, the feature tolerance that can be obtained on the anode plate 14 is not possible with the metal only fuel cell assembly. Further, the fuel cell assembly 10 also has an increased power density resulting from the bonded assembly being able to be made thinner.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled.

What is claimed is:

1. A fuel cell assembly comprising:
a metallic cathode plate;
a composite anode plate;
and a separator disposed between the cathode and anode plates.

2. The assembly of claim 1 wherein the composite anode plate is formed of graphite.

3. The assembly of claim 1, wherein the composite anode plate is formed of conductive composite.

4. The assembly of claim 1, wherein the composite anode plate is partially formed of a metallic material.

5. The assembly of claim 4 wherein the composite anode plate is formed of aluminum.

6. The assembly of claim 1 wherein the composite anode plate is formed of a non-metallic material.

7. A fuel cell assembly comprising:
a metallic cathode plate;
a composite anode plate;
and a separator disposed between the cathode and anode plates, the separator being formed of a reinforcing material.

8. The fuel cell assembly of claim 4 wherein the reinforcing material is formed from carbon fiber cloth.

9. The fuel cell assembly of claim 4 wherein the reinforcing material is formed from fiberglass.

10. The fuel cell assembly of claim 4 wherein the reinforcing material is formed from paper.
